(19) United States
(12) Patent Application Publication
(10) Pub. No.: US 2010/0161838 A1
(43) Pub. Date: Jun. 24, 2010

(54) Host bus adapter with network protocol auto-detection and selection capability

(76) Inventor: David A. Daniel, Scottsdale, AZ (US)

Correspondence Address: Law Office of ROBERT C. KLINGER, 2591 Dallas Parkway, Suite 300, FRISCO, TX, 75034, US

(21) Appl. No.: 12/655,141

(22) Filed: Dec. 23, 2009

Related U.S. Application Data
(60) Provisional application No. 61/203,632, filed on Dec. 24, 2008.

(51) Int. Cl. G06F 3/00

(52) U.S. Cl. 710/8

(57) ABSTRACT

A mechanism for detecting, associating, establishing, and executing an optimal virtualization protocol between a host and a given virtualized device. An Intelligent Host Bus Adapter (IHBA) is claimed that combines storage virtualization with I/O system resource virtualization and incorporates both Dynamic Storage Configuration Protocol (DSCP) and Dynamic I/O Configuration Protocol (DICP) on a common CPU offload platform. The invention enables a comprehensive virtualization solution that includes automatic detection and selection of optimal storage virtualization as well as memory-mapped I/O virtualization protocols on a per resource basis.

### CLAIM OF PRIORITY

This application claims priority of U.S. Provisional Patent Application Ser. No. 61/203,632 entitled “HOST BUS ADAPTER WITH NETWORK PROTOCOL AUTO-DETECTION AND SELECTION CAPABILITY” filed Dec. 24, 2008, the teachings of which are incorporated herein by reference.

### FIELD OF THE INVENTION

The present invention relates to virtualization of computer resources via high speed data networking protocols, and specifically to network adapter cards that implement off-load engines.

### BACKGROUND OF THE INVENTION

There are two main categories of virtualization: 1) Computing Machine Virtualization 2) Resource Virtualization.

Computing machine virtualization involves definition and virtualization of multiple operating system (OS) instances and application stacks into partitions within a host system.

Resource virtualization refers to the abstraction of computer peripheral functions. There are two main types of Resource virtualization: 1) Storage Virtualization 2) System Memory-Mapped I/O Virtualization.

Storage virtualization involves the abstraction and aggregation of multiple physical storage components into logical storage pools that can then be allocated as needed to computing machines. Storage virtualization falls into two categories: 1) File-level Virtualization 2) Block-level Virtualization.

In file-level virtualization, high-level file-based access is implemented. Network-attached Storage (NAS) using file-based protocols such as SMB and NFS is the prominent example.

In block-level virtualization, low-level data block access is implemented. In block-level virtualization, the storage devices appear to the computing machine as if it were locally attached. Storage Attached Network (SAN) is an example of this technical approach. SAN solutions that use block-based protocols include HyperSCSI (SCSI over Ethernet) and iSCSI (SCSI over TCP/IP).

Examples of System Memory-Mapped I/O Virtualization are exemplified by PCI Express I/O Virtualization and i-PCI.

PCIe I/O Virtualization (IOV)

The PCI Special Interest Group (PCI-SIG) has defined single root and multi-root I/O virtualization sharing specifications. Of specific interest is the multi-root specification. The multi-root specification defines the means by which multiple hosts, executing multiple systems instances on disparate processing components, may utilize a common PCI Express (PCIe) switch in a topology to connect to and share common PCI Express resources.

The PCI Express resources are accessed via a shared PCI Express fabric. The resources are typically housed in a physically separate enclosure or card cage. Connections to the enclosure are via a high-performance short-distance cable as defined by the PCI Express External Cabling specification. The PCI Express resources may be serially or simultaneously shared.

A key constraint for PCIe I/O virtualization is the severe distance limitation of the external cabling. There is no provision for the utilization of networks for virtualization.

i-PCI

This invention builds and expands on technology introduced as “i-PCI” in commonly assigned U.S. patent application Ser. No. 12/148,712, the teachings of which are incorporated herein by reference. The present invention provides i-PCI as a new technology for extending computer systems over a network. The i-PCI protocol describes a hardware, software, and firmware architecture that collectively enables virtualization of host memory-mapped I/O systems. For a PCI-based host, this involves extending the PCI I/O system architecture based on PCI Express.

The i-PCI protocol extends the PCI I/O System via encapsulation of PCI Express packets within network routing and transport layers and Ethernet packets and then utilizes the network as a transport. The network is made transparent to the host and thus the remote I/O appears to the host system as an integral part of the local PCI system architecture. The result is a virtualization of the host PCI System. The i-PCI protocol allows certain hardware devices (in particular I/O devices) native to the host architecture (including bridges, I/O controllers, and I/O cards) to be located remotely. FIG. 1 shows a detailed functional block diagram of a typical host system connected to multiple remote I/O chassis. An i-PCI host bus adapter card [101] installed in a host PCI Express slot [102] interfaces the host to the network. An i-PCI remote bus adapter card [103] interfaces the remote PCI Express bus resources to the network.

There are three basic implementations of i-PCI:

1. i-PCI: This is the TCP/IP implementation, utilizing IP addressing and routers. This implementation is the least efficient and results in the lowest data throughput of the three options, but it maximizes flexibility in quantity and distribution of the I/O units. Refer to FIG. 2, for an i-PCI IP-based network implementation block diagram.

2. i(e)-PCI: This is the LAN implementation, utilizing MAC addresses and Ethernet switches. This implementation is more efficient than the i-PCI TCP/IP implementation, but is less efficient than i(dc)-PCI. It allows for a large number of locally connected I/O units. Refer to FIG. 3 for an, i(e)-PCI MAC-Address switched LAN implementation block diagram.

3. i(dc)-PCI. Referring to FIG. 4, this is a direct physical connect (802.3an) implementation, utilizing Ethernet CAT-x cables. This implementation is the most efficient and highest data throughput option, but it is limited to a single remote I/O unit. The standard implementation utilizes 10 Gbps Ethernet (802.3ae) for the link [401] however; there are two other lower performance variations. These are designated the “Low End” LE(dc) or low performance variations, typically suitable for embedded or cost sensitive installations:

The first low end variation is LE(dc) Triple link Aggregation 1 Gbps Ethernet (802.3ab) [402] for mapping to single-lane 2.5 Gbps PCI Express [403] at the remote I/O.

A second variation is LE(dc) Single link 1 Gbps Ethernet [404] for mapping single-lane 2.5 Gbps PCI Express [405] on a host to a legacy 32-bit/33 MHz PCI bus-based [406] remote I/O.

Software-only implementations of i-PCI enable i-PCI capability for applications where an i-PCI host bus adapter and/or remote bus adapter may not be desirable or feasible. Software-only implementations trade off relative high performance for freedom from physical hardware requirements and constraints. Software-only i-PCI also allows remote access to PCIe IOV resources via host-to-host network connections.

Automatic Configuration Protocols:

Automatic Configuration Protocols are part of the current art. There have been several automatic configuration protocols introduced over recent years, typically as a lower-level protocol that is part of a higher standard. These include:

Universal Serial Bus (USB) with its ability to automatically detect and configure devices via a “surprise” attach/detach event.

PCI and PCI Express, with its non-surprise or signaled “hot plug” insertion/removal capability.

Bootp, as a part of UDP, used as a means for a client to automatically have its IP address assigned.

Reverse Address Resolution Protocol (RARP), part of TCP/IP, used as a means for a host system to obtain its IP or network address based on its Ethernet or data link layer address.

Address Resolution Protocol (ARP), part of TCP/IP, used as a protocol by which a host may determine another host's Ethernet or data link layer address based on the IP or network address it has for the host.

Dynamic Host Configuration Protocol (DHCP), as part of TCP/IP, which allows network devices to be added through automating the assignment of various IP parameters, including IP addresses.

Dynamic Storage Configuration Protocol (DSCP). This invention builds and expands on technology introduced as “DSCP” in commonly assigned U.S. Patent Application Ser. No. 61/203,619, the teachings of which are incorporated herein by reference. DSCP enables automatic detection and selection of an optimal network storage virtualization protocol on a per resource basis, based on various factors, including the network topology, location of the storage devices in relation to the topology, and the available storage virtualization protocols. DSCP is applicable for use in extended system network applications where multiple network storage virtualization protocols are implemented including, but not limited to iSCSI, HyperSCSI, and “SCSI over i-PCI”. (For reference, i-PCI may be applied to include SCSI simply though the use of a standard SCSI adapter card installed in a PCI or PCI Express-based expansion chassis, thus the term “SCSI over i-PCI”).

Dynamic I/O Configuration Protocol (DICP). This invention builds and expands on technology introduced as “DICP” in commonly assigned U.S. Patent Application Ser. No. 61/203,618, the teachings of which are incorporated herein by reference. DICP enables automatic detection and selection of an optimal I/O system resource virtualization protocol on a per resource basis, based on various factors, including the network topology, location of the I/O system resource devices in relation to the topology, and the available I/O system resource virtualization protocols. DICP is applicable for use in extended system network applications where multiple I/O system resource virtualization protocols are implemented including, but not limited to PCIe I/O Virtualization (IOV), i-PCI, i(e)-PCI, and i(dc)-PCI and its variants. (Note that i-PCI, i(e)-PCI, i(dc)-PCI and its variants are as described in commonly assigned U.S. patent application Ser. No. 12/148,712, the teachings of which are incorporated herein by reference.)

In the current state of the art, there are multiple storage virtualization standards. In order to make the best choice among the standards for a given application, the user has to inspect the network topology, note the physical location of the targeted storage devices relative to the host, and understand the possible protocols that could be used to virtualize the storage resources to achieve the best performance (i.e. highest data rate, lowest latency). The level of expertise and the time required to complete a study of the network to achieve the best data transfers is too time consuming. As a result, most users must rely on networking experts or simply default their configuration to a single storage virtualization protocol—which typically is not ideal for all their storage devices.

In the current state of the art, there are also multiple I/O system virtualization standards. In order to make the best choice among the standards for a given application, the user has to inspect the computer architecture and network topology, note the physical location of the targeted I/O resources relative to the host, and understand the possible protocols that could be used to virtualize the I/O resources to achieve the best performance (i.e. highest data rate, lowest latency). The level of expertise and the time required to complete a study of the computer system and network to achieve the best data transfers is too time consuming. As a result, most users must rely on computer system and networking experts or simply default their configuration to a single I/O virtualization protocol—which typically is not ideal for all their I/O resources.

### SUMMARY OF THE INVENTION

The present invention achieves technical advantages as an Intelligent Host Bus Adapter (IHBA) that incorporates both Dynamic Storage Configuration Protocol and Dynamic I/O Configuration Protocol thus facilitating automatic detection and selection of optimal storage virtualization and memory-mapped I/O virtualization protocols on a per resource basis.

The invention is a solution for:

1. The problem of complexity and the resulting lack of optimization in storage virtualization implementations. The invention shields the user from the complexity of network analysis and allows the engaging of multiple storage virtualization protocols—as opposed to a single protocol. The invention enables automatic detection and selection of an optimal network storage virtualization protocol on a per resource basis in a host bus adapter, which is a unique capability and something that has not been accomplished in the prior art. The net result is a simplified user experience and optimized performance when using virtualized storage.

2. The problem of complexity and the resulting lack of optimization in I/O system resource virtualization implementations. The invention shields the user from the complexity of computer and network analysis and allows the engaging of multiple I/O system resource virtualization protocols—as opposed to a single protocol. The invention enables automatic detection and selection of an optimal I/O system resource virtualization protocol on a per resource basis in a host bus adapter, which is a unique capability and something that has not been accomplished in the prior art. The net result is a simplified user experience and optimized performance when using virtualized I/O system resources.

3. The problem of processor overload resulting from virtualization processing demands. As networking data rates and bandwidth demands rapidly increase, Central Processor Unit (CPU) processing capacity struggles to stay up with the pace. As a result severe system performance degradation is typical when there are bandwidth intensive and processing intensive applications like video, data backup, and virtualization. The invention offloads the CPU by processing virtualization-related functions in a host bus adapter.

### BRIEF DESCRIPTION OF THE DRAWINGS

FIG. 1 shows a detailed functional block diagram of a typical host system connected to multiple remote I/O chassis implementing i-PCI;

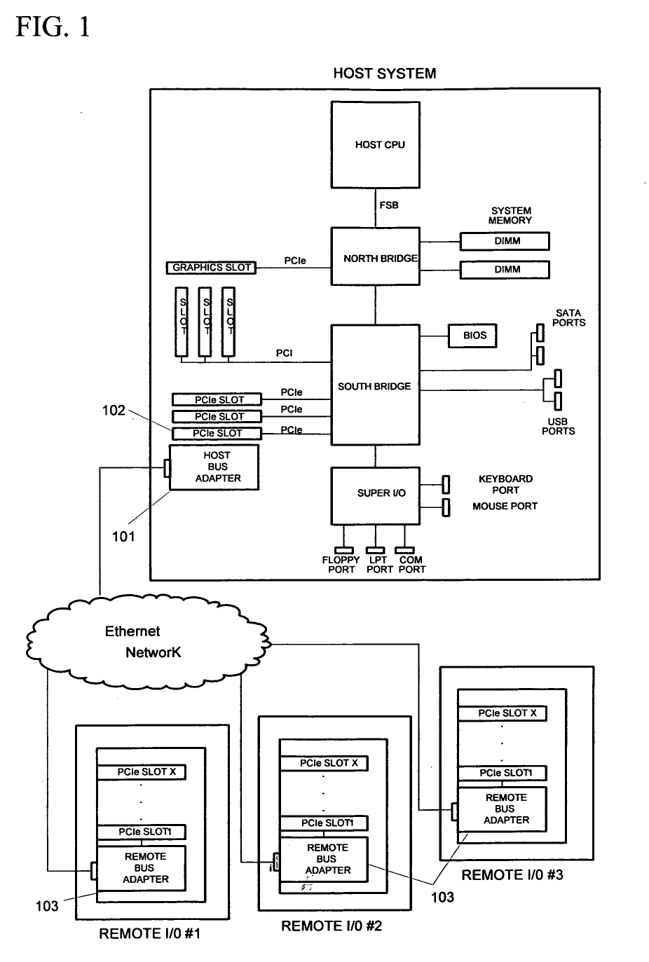

FIG. 2 is a block diagram of an i-PCI IP-based network implementation;

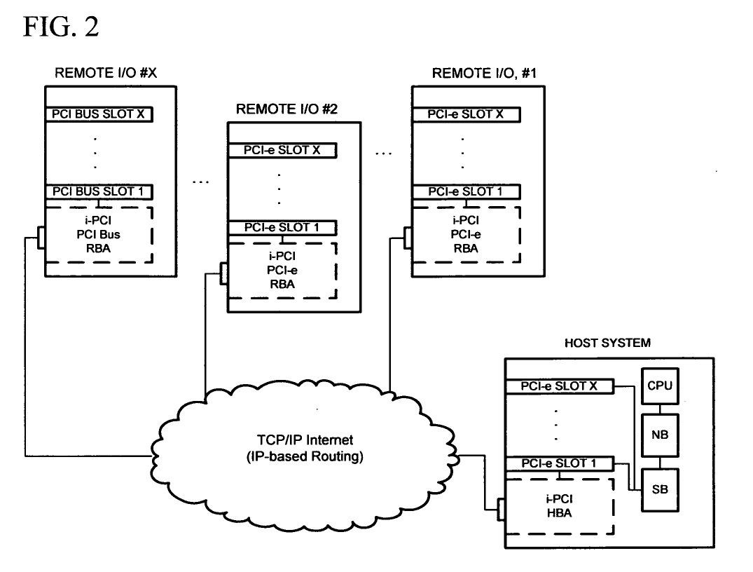

FIG. 3 is a block diagram of an, i(e)-PCI MAC-Address switched LAN implementation;

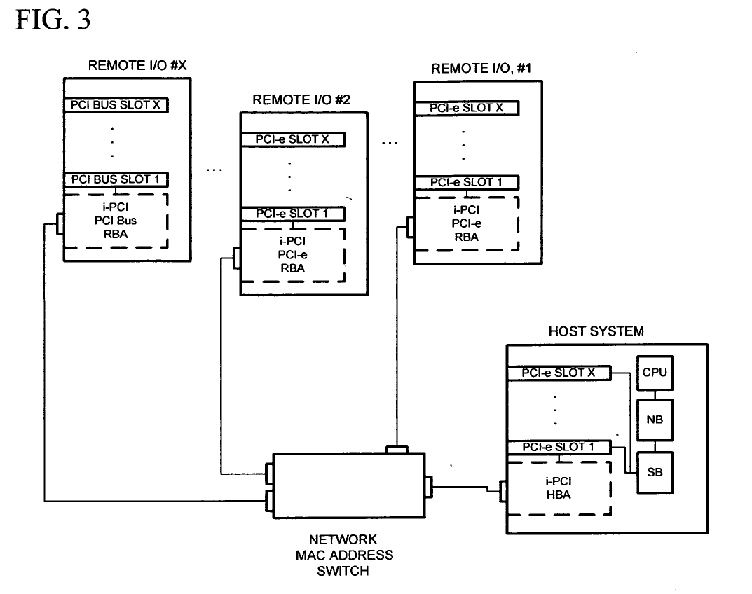

FIG. 4 is a block diagram of various direct physical connect i(dc)-PCI implementations, utilizing Ethernet CAT-x cables;

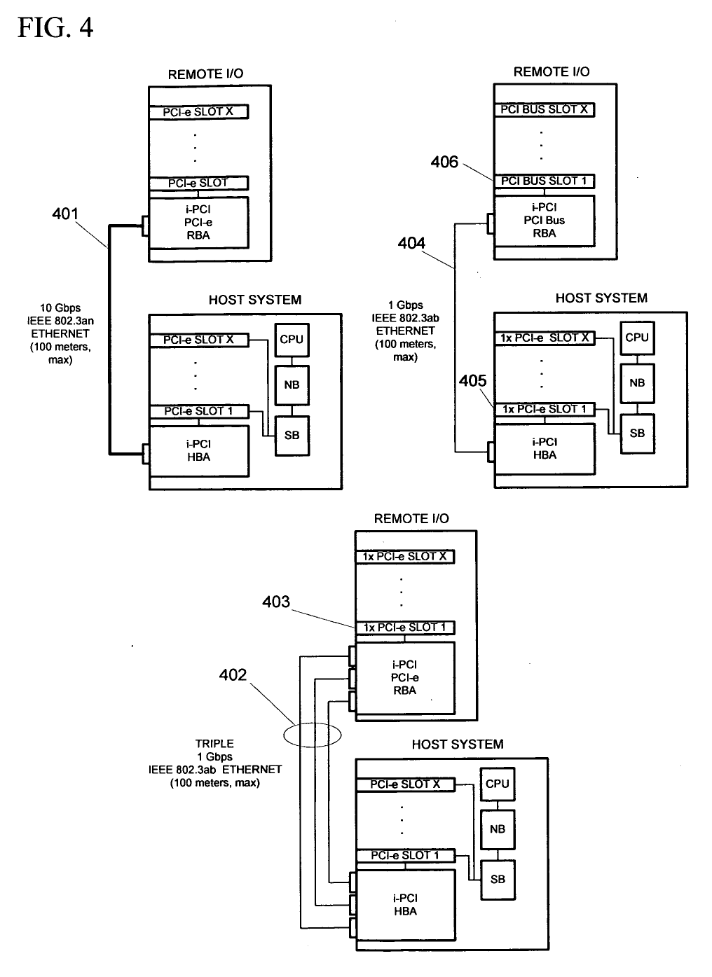

FIG. 5 depicts the physical layout of an example Intelligent Host Bus Adapter (IHBA) in a PCI Express adapter card form factor;

FIG. 6 is an illustration of the IHBA architecture that supports storage and I/O virtualization, Dynamic Storage Configuration Protocol (DSCP) and the Dynamic I/O Configuration Protocol (DICP);

FIG. 7 is an illustration of a complete basic functionality Dynamic Storage Configuration Protocol (DSCP) network environment;

FIG. 8 shows the Storage Associations established and maintained in table format on the DSCP server;

FIG. 9 shows the construction of the Protocol Pairings table, a version of which is stored on each client system;

FIG. 10 shows the relationship of the various storage protocols to the OSI layers;

FIG. 11 details the pseudo-code for the pairing algorithm;

FIG. 12, shows a basic functionality DSCP state machine for both client and server;

FIG. 13 summarizes the state descriptions associated with the various DSCP states;

FIG. 14 is an illustration of a complete basic functionality Dynamic I/O Configuration Protocol (DICP) network environment;

FIG. 15 shows the Remote I/O Resource Associations established and maintained in table format on the DICP server;

FIG. 16 shows the construction of the Protocol Pairings table, a version of which is stored on each client system;

FIG. 17 shows the relationship of the various I/O Resource Virtualization protocols to the OSI layers;

FIG. 18 details the pseudo-code for the pairing algorithm;

FIG. 19 shows a basic functionality DICP state machine for both client and server; and

FIG. 20 summarizes the state descriptions associated with the various DICP states.

### DETAILED DESCRIPTION OF THE PRESENT INVENTION

The invention is an Intelligent Host Bus Adapter (IHBA) that combines storage virtualization with I/O system resource virtualization and incorporates both Dynamic Storage Configuration Protocol (DSCP) and Dynamic I/O Configuration Protocol (DICP) on a common CPU offload platform. The IHBA effectively combines support for i-PCI, PCIe IOV, and storage virtualization (including iSCSI). The invention thus enables a comprehensive high-performance solution that includes automatic detection and selection of optimal storage virtualization as well as memory-mapped I/O virtualization protocols on a per resource basis.

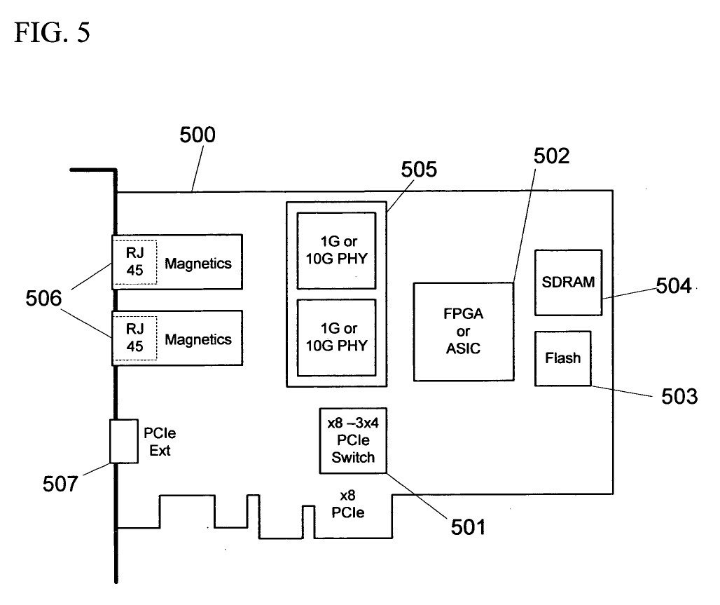

FIG. 5 shows a physical layout of an example IHBA [500] in a PCI Express adapter card form factor. The major components include a PCI Express (PCIe) switch [501] which provides an upstream port and three downstream ports, an FPGA or ASIC [502] that includes the logic and programming necessary to accommodate storage and system I/O resource virtualization, DSCP, and DICP, supporting flash for non-volatile memory and configuration register usage [503], SDRAM for FPGA or ASIC soft-core processor utilization [504], Dual 1G or 10G PHYs [505]—one for the physical layer network interface and one for an optional i(dc)-PCI connection—associated network magnetics and connectors [506], and an external PCI Express cable connector [507] for an optional PCIe IOV connection.

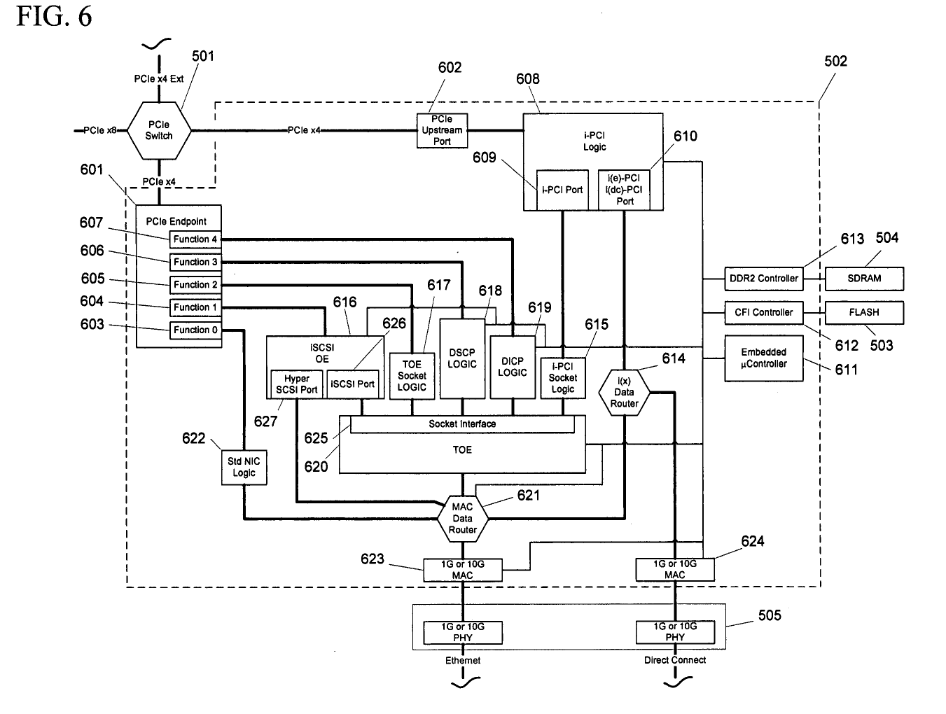

The IHBA FPGA or ASIC major functional blocks associated with the invention are depicted in FIG. 6. A novel aspect of the overall architecture is the implementation of DSCP [618] and DICP [619] support in separate logic blocks. DSCP and DICP are implemented as PCIe Endpoint functions [606] [607] interfacing to the TOE [620] via a socket interface [625].

During host boot-up and enumeration of the PCI bus, the host software discovers PCIe switch [501], the PCIe Upstream Port [602] and the multi-function PCIe Endpoint [601]. The devices are initialized per the PCIe specification. Each function in the multi-function PCIe Endpoint is also initialized. A PCIe Endpoint device may have up to eight functions. The example design in FIG. 6 utilizes five of the possible eight functions.

Referring to FIG. 6:

Function 0 [603] is the standard Network Interface Card (NIC) function, which bypasses the TCP/IP Offload engine (TOE) [620]. Standard NIC logic [622] interfaces Function 0 [603] to/from the MAC Data Router [621]. The MAC Data Router directs standard NIC transactions to/from the common Media Access Controller (MAC) [623]. The transactions are translated to/from physical layer signaling by the Dual PHY [505].

Function 1 [604] is the iSCSI Offload Engine function. This function is engaged when the iSCSI offload capability is desired in storage virtualization applications. The iSCSI OE [616] accomplishes hardware acceleration of the iSCSI protocol and interfaces Function 1 [604] to/from the TOE [620] via the Socket Interface [625] or alternately to/from the MAC Data Router [621] via the Hyper SCSI port [627] in the case of Hyper SCSI. The TOE [620] works with the iSCSI OE to effectively reduce the CPU utilization and increases data throughput speeds for the iSCSI and Internet protocols. TOE transactions are transferred to/from the MAC Data Router [621]. For both iSCSI and Hyper SCSI, the MAC Data Router [621] directs transactions to/from the Media Access Controller (MAC) [623]. The transactions are translated to/from physical layer signaling by the Dual PHY [505].

Function 2 [605] is the TOE function. This function is engaged when the TCP/IP offload capability is desired. TOE Socket Logic [617] interfaces Function 2 [605] to/from the TOE [620] via the Socket Interface [625]. The TOE [620] effectively reduces the CPU utilization and increases data throughput speeds for the Internet protocol. TOE transactions are transferred to/from the MAC Data Router [621]. The MAC Data Router [621] directs TOE transactions to/from the MAC [623]. The transactions are translated to/from physical layer signaling by the Dual PHY [505].

Function 3 [606] is the DSCP function. This function is engaged when the Dynamic Storage Configuration Protocol is active. DSCP Logic [618] offloads and supports the DSCP protocol, implementing the capabilities as described in commonly assigned U.S. Patent Application Ser. No. 61/203,619, the teachings of which are incorporated herein by reference. The DSCP Logic interfaces Function 3 [606] to/from the TOE [620] via the Socket Interface [625]. The TOE [620] effectively reduces the CPU utilization and increases data throughput speeds for the Internet protocol. TOE transactions are transferred to/from the MAC Data Router [621]. The MAC Data Router [621] directs TOE transactions to/from the Media Access Controller (MAC) [623]. The transactions are translated to/from physical layer signaling by the Dual PHY [505].

Function 4 [607] is the DICP function. This function is engaged when the Dynamic I/O Configuration Protocol is active. DICP Logic [619] offloads and supports the DICP protocol, implementing the capabilities as described in commonly assigned U.S. Patent Application Ser. No. 61/203,618, the teachings of which are incorporated herein by reference. The DICP Logic interfaces Function 4 [607] to/from the TOE [620] via the Socket Interface [625]. The TOE [620] effectively reduces the CPU utilization and increases data throughput speeds for the Internet protocol. TOE transactions are transferred to/from the MAC Data Router [621]. The MAC Data Router [621] directs TOE transactions to/from the Media Access Controller (MAC) [623]. The transactions are translated to/from physical layer signaling by the Dual PHY [505].

The i-PCI Logic [608] accomplishes the system I/O resource virtualization, as described in commonly assigned U.S. patent application Ser. No. 12/148,712, the teachings of which are incorporated herein by reference. The i-PCI logic performs encapsulation/un-encapsulation, and utilizes latency and timeout mitigation to uniquely enable effective I/O resource virtualization. The i-PCI Logic interfaces the PCIe Upstream port [602] to/from the TOE [620] via the i-PCI port [609], i-PCI Socket Logic [615] and Socket Interface [625]. The TOE [620] works with the i-PCI Logic to effectively reduce the CPU utilization and increases data throughput speeds for the i-PCI and Internet protocols. Alternatively, i(e)-PCI or i(dc)-PCI transactions are routed around the TOE via the i(e)-PCI i(dc)-PCI port [610] and the i(x) Data Router [614]. If the i-PCI protocol is the i(dc)-PCI variant, the transaction routes to/from a separate MAC [624]. If the i-PCI protocol is the i(e)-PCI variant, the transactions are routed to the common MAC [623]. In all cases, the transactions are translated to/from physical layer signaling by the Dual PHY [505].

The PCIe switch [501] includes a downstream port that routes to the PCIe External connector [507]. PCIe IOV is accomplished via this downstream port. An external expansion chassis may be connected via this port.

Supporting management blocks onboard the IHBA include an embedded microcontroller [611] for configuration and status capabilities, a CFI controller [612] for interfacing to flash memory, and a DDR2 SDRAM memory controller [613] for use by the microcontroller software.

DSCP, as facilitated by the IHBA, enables automatic detection and selection of an optimal network storage virtualization protocol on a per resource basis, based on various factors, including the network topology, location of the storage devices in relation to the topology, and the available storage virtualization protocols.

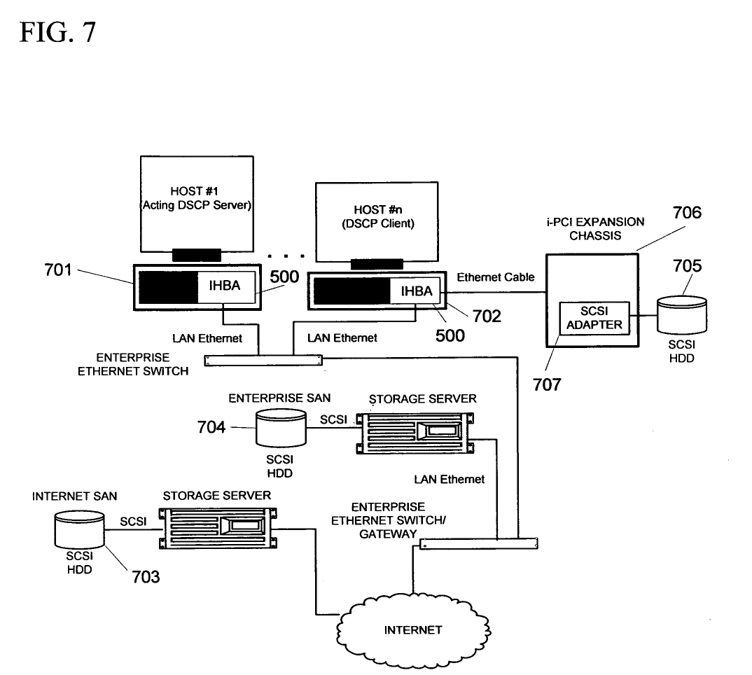

Referring to FIG. 7, It may be seen how the IHBA [500] fits into the overall deployment and implementation of DSCP. The DSCP solution consists of the following components and functions:

DSCP Server: DSCP includes both server and client roles. A given host may act as a DSCP server [701] or client [702]. Each server contains a supporting IHBA [500]. If there is no DSCP server on a network at the time a host is added to a network, it by default becomes the DSCP server. In one preferred embodiment, the DSCP server function is installed on the server that is also managing the general network parameter assignments via a protocol such as DHCP. Thus the same server also determines and configures the network storage virtualization protocols. If a host is set as a DSCP server, first time configuration is accomplished via a System Data Transfer Utility (SDTU).

DSCP Probe Function: DSCP Probe is a simple network access utility that is engaged as part of the host boot-up sequence. DSCP Probe sends out a broadcast on the LAN to determine if there are any other hosts already acting as a DSCP server. If there is no response, it is assumed the host must also function as a DSCP server and hands off execution to the System Data Transfer Utility.

System Data Transfer Utility (SDTU): The SDTU is an installed software that is optionally engaged as part of the host boot-up sequence. If no DSCP server is present on a network at the time a host is added to the network, that host, by default, assumes the DSCP server role. A “No DSCP Server” found message is communicated to the user and the System Data Transfer Utility is engaged to interact with the user. The SDTU creates a complete mapping table, referred to as the Storage Associations of all network host and storage pairings. The Storage Association is stored in the DSCP logic block onboard the IHBA [500]. Storage resources may be available at various locations on a network, including but not limited to Internet Storage Area Network (SAN) [703], Enterprise SAN [704], SCSI over i-PCI storage [705]. The SDTU may use pre-configured default pairings as defined by the DSCP Pairings Algorithm or it optionally may allow administrator interaction or over-rides to achieve network or system configuration and optimization goals. Once the SDTU has been run, the host is then rebooted, the DSCP function [606] onboard the IHBA [500] is discovered and enumerated and the host then becomes the active DSCP server. The DSCP server then responds to probes from any other host system on the network. Any other hosts subsequently added to the system would then discover the DSCP server when they execute their Probe Function and thus would configure themselves as a client.

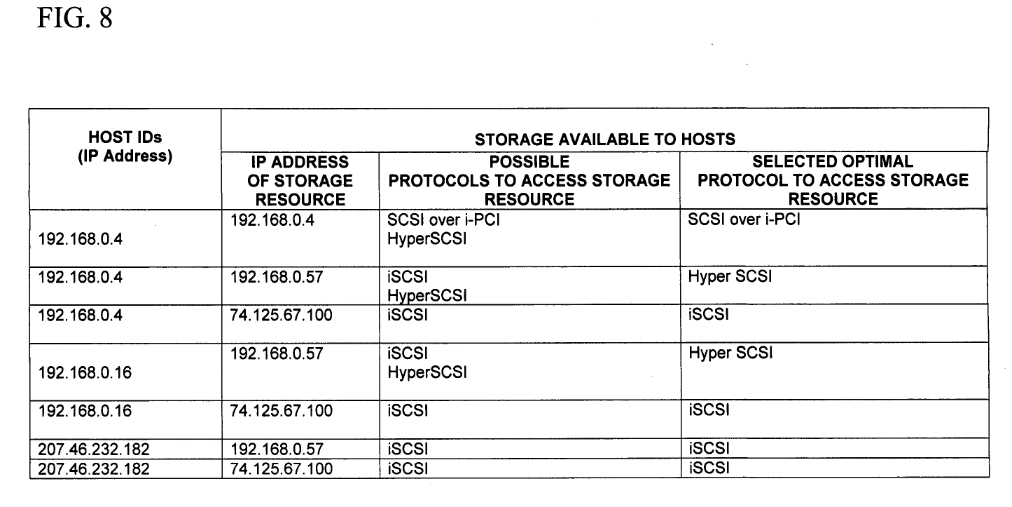

Storage Associations: Associations between host and virtualized storage are established such that virtualization protocols may be engaged that are optimal. Multiple protocols may be engaged with one protocol associated with a storage resource and another protocol associated with another storage resource such that optimal data transfer is achieved for each host-to-resource pairing. FIG. 8 shows the construction of a table for the Storage Associations. The Storage Association table is stored in the DSCP logic block onboard the IHBA [500].

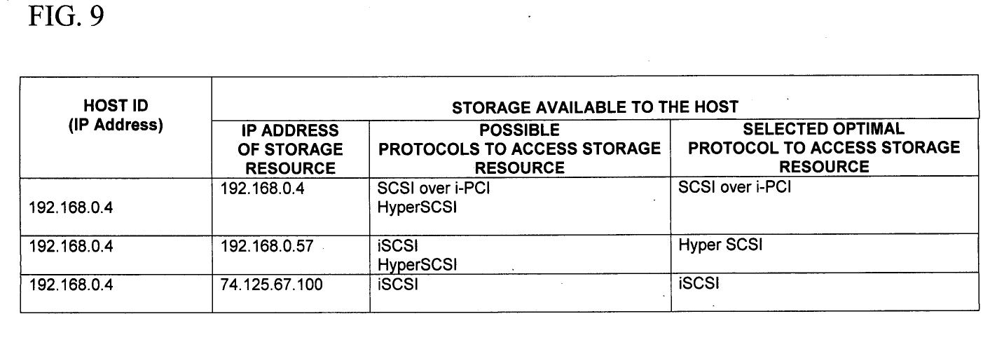

DSCP Client: DSCP is executed as a precursor to session management. Each client contains a supporting IHBA [500]. A host system, executing DSCP as a client, determines the optimal virtualization protocol to use for data storage, based on the network topology settings stored in “Storage Associations” located on the DSCP Server. The Storage Association on the DSCP Server is accessed by the DSCP client and the optimal protocol is configured for each storage device it is mapped to on the network. The locally stored configuration is referred to as the Optimal Protocol Pairings. FIG. 9 shows the construction of the Protocol Pairings, which is simply a downloaded current subset of the Storage Associations found on the DSCP Server. The Protocol Pairings is stored in the DSCP logic block [618] onboard the IHBA [500].

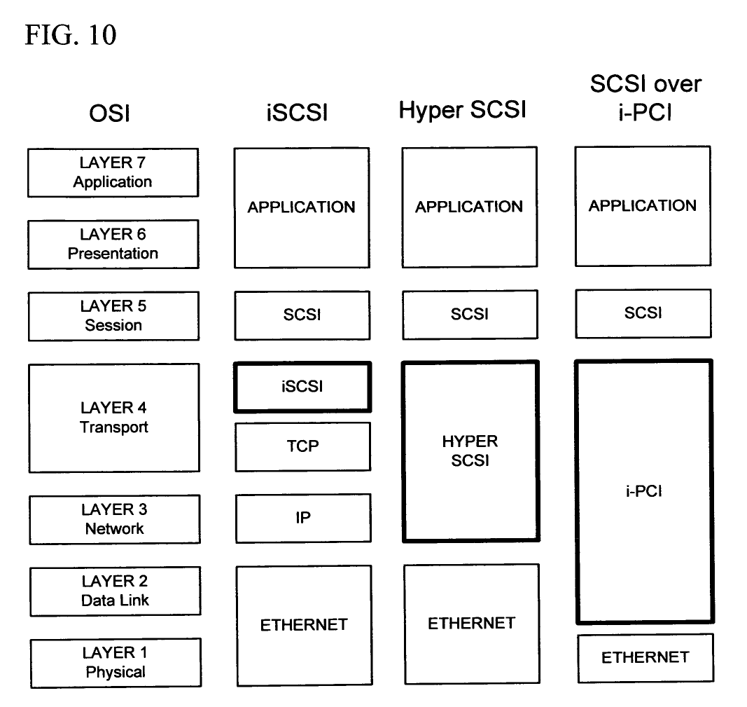

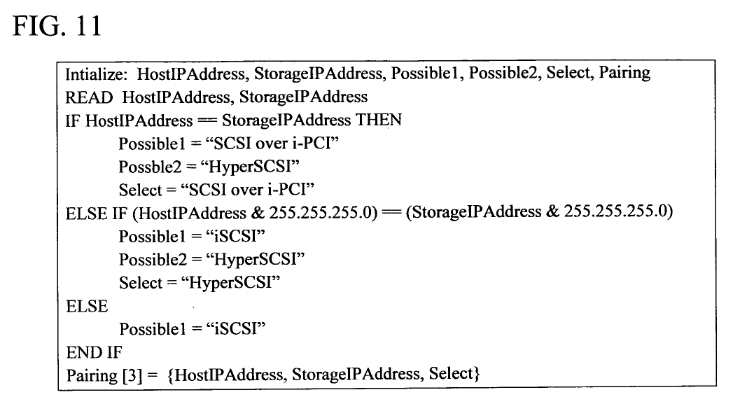

DSCP Pairings Algorithm: The DSCP pairings algorithm executes as a function within the SDTU software. The algorithm is based on a simple performance rule: To maximize performance, the protocol operating at the lowest OSI layer is selected. FIG. 10 shows the relationship of the various storage protocols to the OSI layers. Referring to FIG. 10 and FIG. 7, for example, if there is a direct connect via i-PCI to an expansion chassis [706] that includes a SCSI adapter [707] which connects to SCSI hard drives [705], it is selected over HyperSCSI. In another example, an iSCSI server and SAN [704] located on a peer Ethernet switch port would be connected to via HyperSCSI, rather than iSCSI. FIG. 11 details the simplified pseudo-code for the pairing algorithm for a single entry as a means of illustrating the concept.

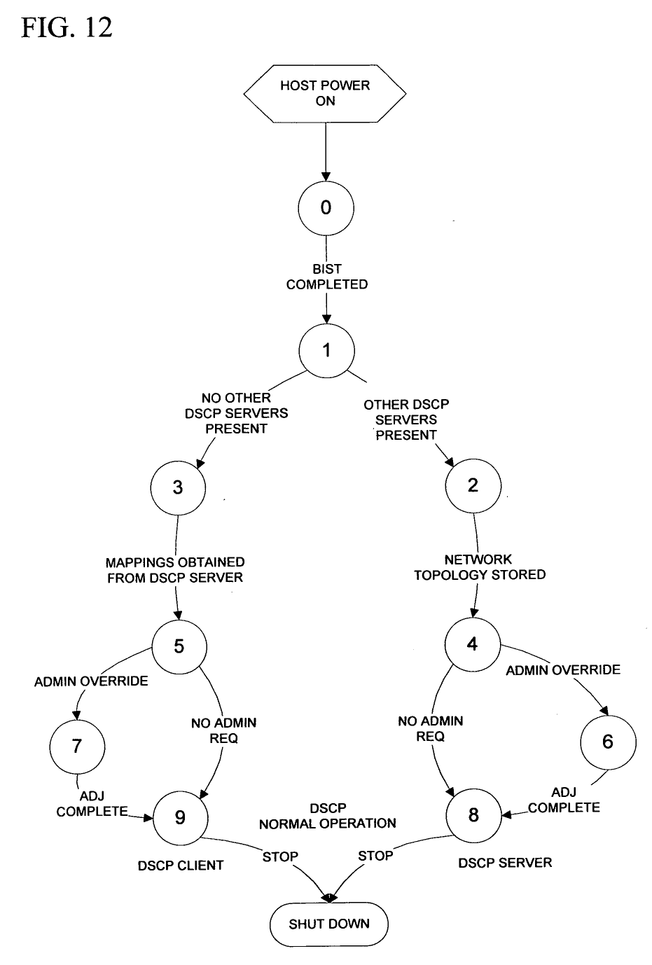

Referring to FIG. 12, a basic functionality DSCP state machine for both client and server is shown.

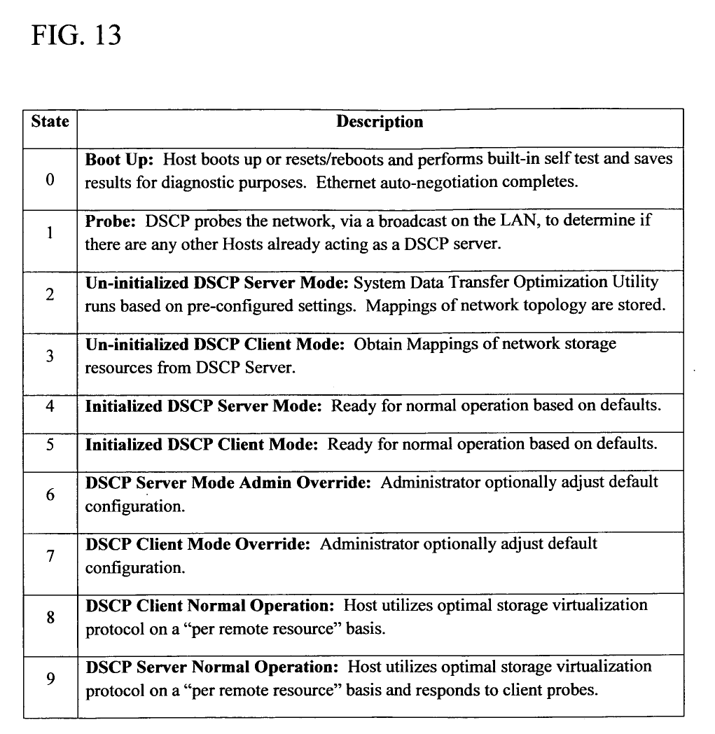

FIG. 13 summarizes the state descriptions associated with the various DSCP states illustrated in FIG. 12.

DICP, as incorporated by the IHBA, enables automatic detection and selection of an optimal I/O system resource virtualization protocol on a per resource basis, based on various factors, including the network topology, location of the I/O system resource devices in relation to the topology, and the available I/O system resource virtualization protocols.

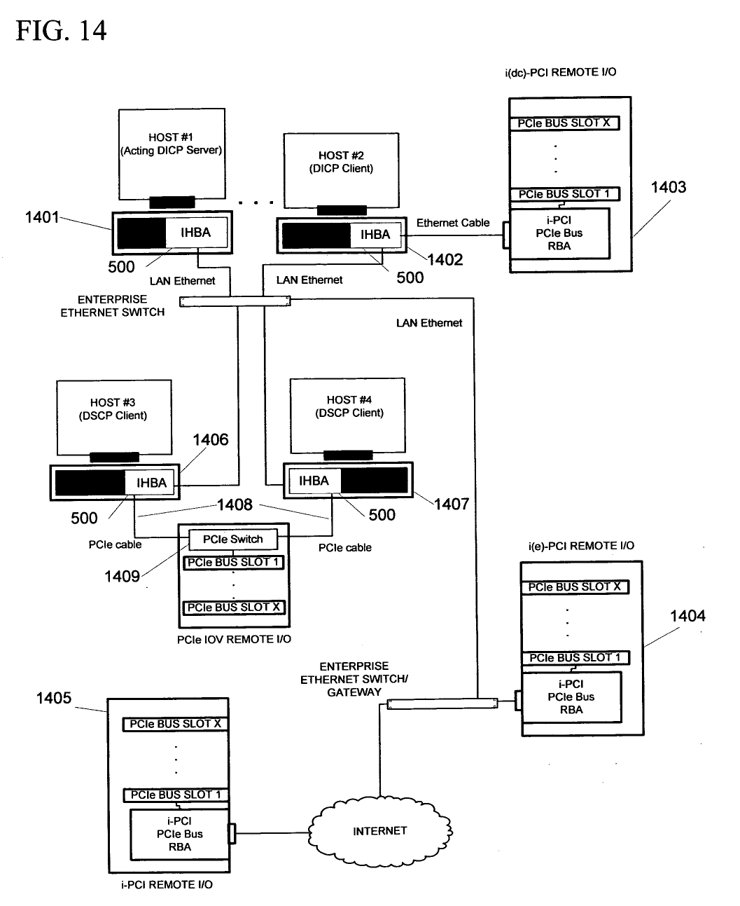

Referring to FIG. 14, it may be seen how the IHBA [500] fits into the overall deployment and implementation of DICP. The DICP solution consists of the following components and functions:

DICP Server: DICP includes both server and client roles. A given host may act as a DICP server [1401] or client [1402] [1406] [1407]. If there is no DICP server on a network at the time a host is added to a network, it by default becomes the DICP server. Each server contains a supporting IHBA [500]. In one preferred embodiment, the DICP server function is installed on the server that is also managing the general network parameter assignments via a protocol such as DHCP. Thus the same server also determines and configures the I/O system resource virtualization protocols. If a host is set as a DICP server, first time configuration is accomplished via the System Data Transfer Utility (SDTU).

DICP Probe Function: DICP Probe is a simple network access utility that is engaged as part of the host boot-up sequence. DICP Probe sends out a broadcast on the LAN to determine if there are any other hosts already acting as a DICP server. If there is no response, it is assumed the host must also function as a DICP server and hands off execution to the System Data Transfer Utility.

System Data Transfer Utility (SDTU): The SDTU is an installed software that is optionally engaged as part of the host boot-up sequence. If no DICP server is present on a network at the time a host is added to the network, that host, by default, assumes the DICP server role. A “No DICP Server” found message is communicated to the user and the System Data Transfer Utility is engaged to interact with the user. The SDTU creates a complete mapping table, referred to as the I/O System Resource Associations of all network host and I/O system resource pairings. I/O system resources may be available at various locations on a network, including but not limited to i(dc)-PCI remote resources [1403], i(e)-PCI remote resources [1404], i-PCI remote resources [1405] and multi-root PCIe IOV enabled resources shared between two hosts [1406][1407] via PCIe cables [1408] and a PCIe switch [1409]. The SDTU may use pre-configured default pairings as defined by the DICP Pairings Algorithm or it optionally may allow administrator interaction or over-rides to achieve network or system configuration and optimization goals. Once the SDTU has been run, the host is then rebooted, the DICP function [607] onboard the IHBA [500] is discovered and enumerated and the host then becomes the active DICP server. The DICP server then responds to probes from any other host system on the network. Any other hosts subsequently added to the system would then discover the DICP server when they execute their Probe Function and thus would configure themselves as a client.

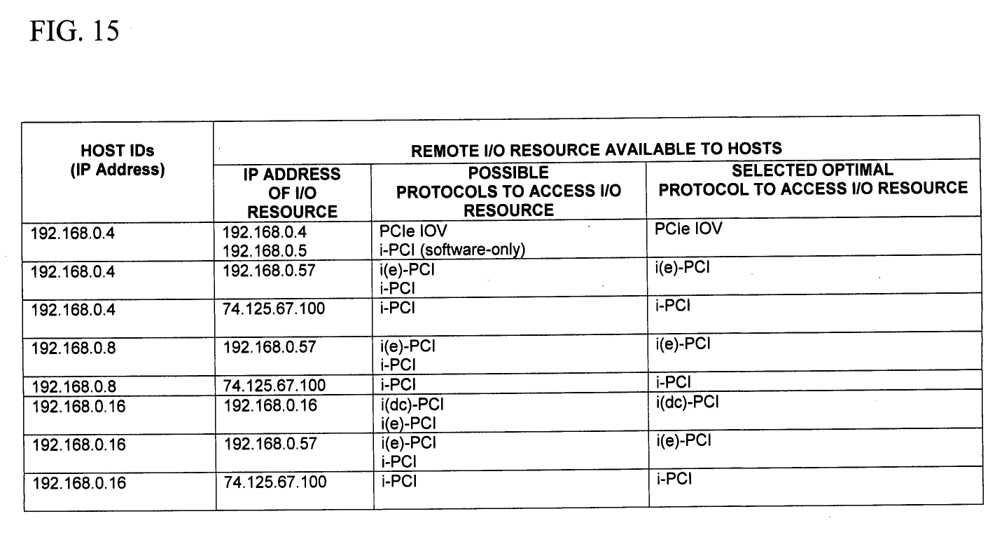

I/O system resource Associations: Associations between host and virtualized I/O system resource are established such that virtualization protocols may be engaged that are optimal. Multiple protocols may be engaged with one protocol associated with an I/O system resource and another protocol associated with another I/O system resource such that optimal data transfer is achieved for each host-to-resource pairing. The Associations are stored on the IHBA [500] located at the DICP Server [1401]. FIG. 15 shows the construction of a table for the I/O system resource Associations.

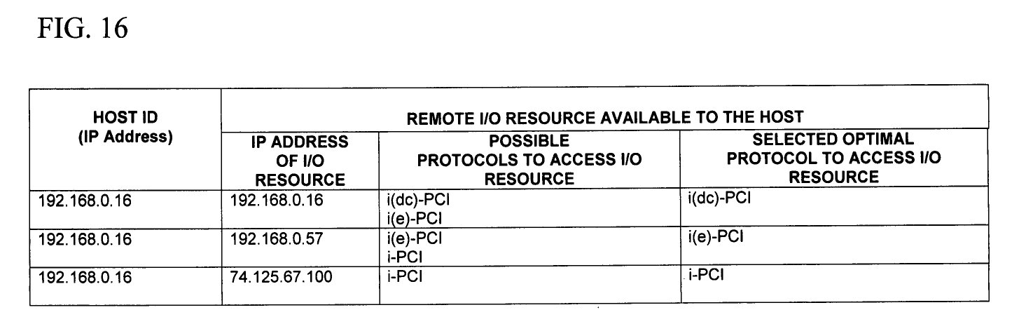

DICP Client: Each client contains a supporting IHBA [500]. DICP is executed as a precursor to session management. A host system [1402][1406][1407], executing DICP as a client, determines the optimal virtualization protocol to use for a given data I/O system resource, based on the network topology settings stored in “I/O system resource Associations” located on the DICP Server IHBA. The I/O system resource Association on the DICP Server IHBA is accessed by the DICP client and the optimal protocol is configured for each I/O system resource device it is mapped to on the network. The locally stored configuration is referred to as the Optimal Protocol Pairings. FIG. 16 shows the construction of the Protocol Pairings, which is simply a downloaded current subset of the I/O system resource Associations—specific to that particular host—found on the DICP Server. The Protocol Pairings is stored locally in the DICP logic block [619] onboard the IHBA [500].

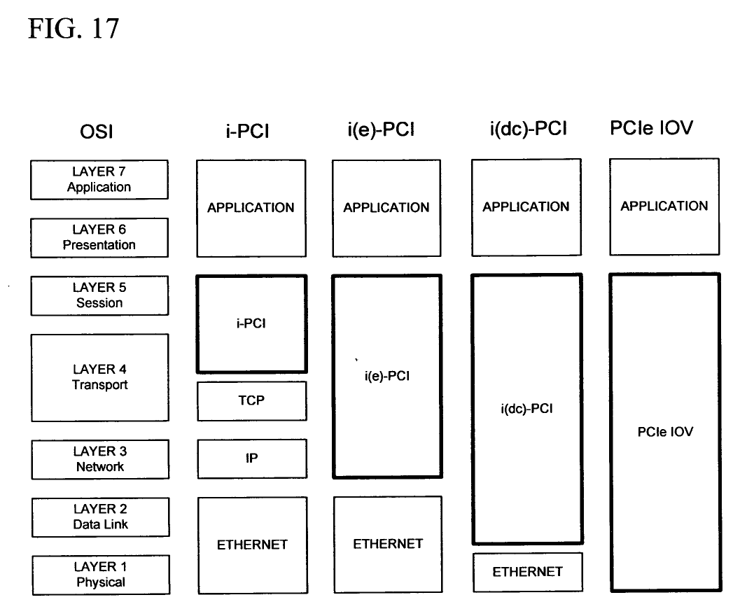

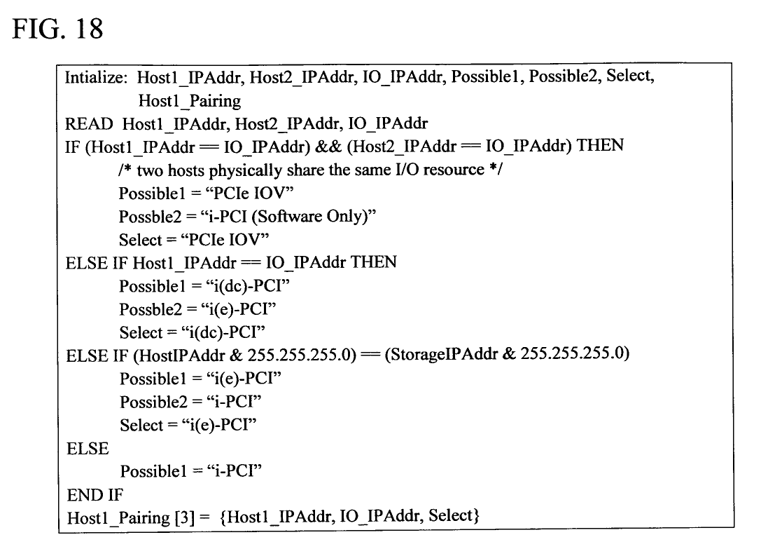

DICP Pairings Algorithm: The DICP pairings algorithm executes as a function within the SDTU software. The algorithm is based on a simple performance rule: To maximize performance, the protocol operating at the lowest OSI layer is selected. FIG. 17 shows the relationship of the various I/O system resource protocols to the OSI layers. Referring to FIG. 14 and FIG. 17, for example, if there is a PCIe cable connection [1408] via a PCIe switch [1409] to I/O resources, PCIe IOV is selected over i-PCI. In another example, a host and Remote I/O located on a peer port of the local network Ethernet switch would be connected to via i(e)-PCI, rather than i-PCI. FIG. 18 details the simplified pseudo-code for the pairing algorithm for a single entry as a means of illustrating the concept.

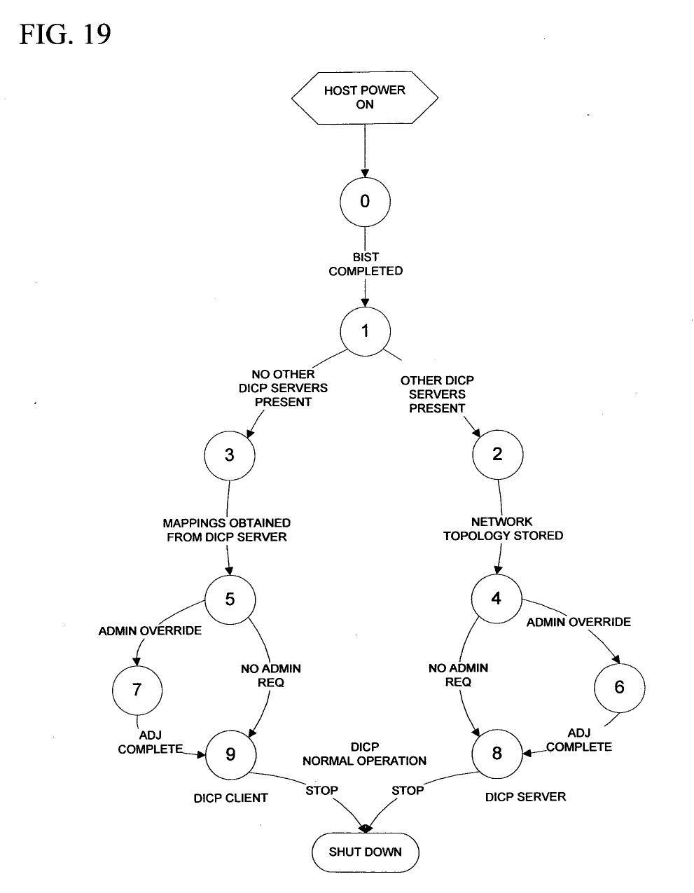

Referring to FIG. 19, a basic functionality DICP state machine for both client and server is shown.

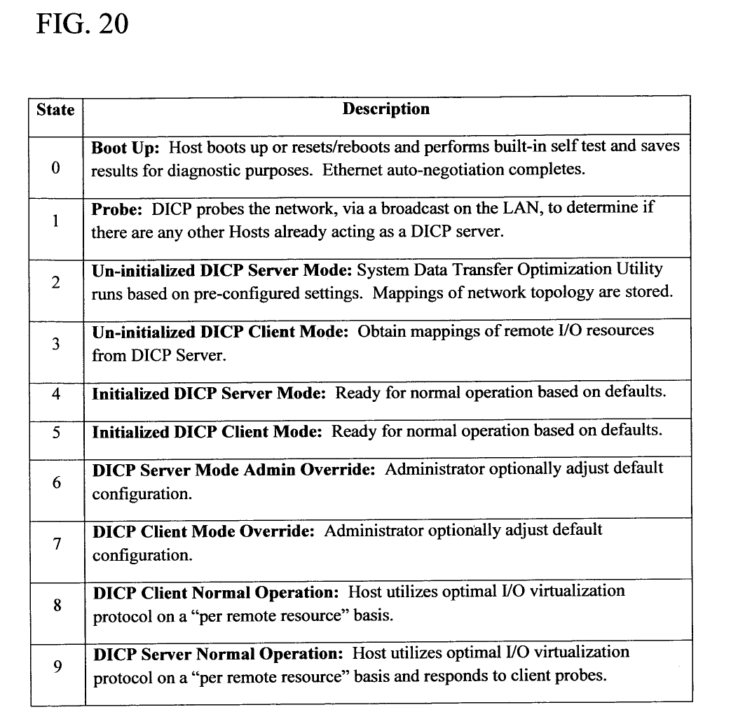

FIG. 20 summarizes the state descriptions associated with the various DICP states illustrated in FIG. 17.

Though the invention has been described with respect to a specific preferred embodiment, many variations and modifications will become apparent to those skilled in the art upon reading the present application. The intention is therefore that the appended claims be interpreted as broadly as possible in view of the prior art to include all such variations and modifications.

What is claimed is:

1. A module configured to detect, associate, establish, and execute an optimal virtualization protocol between a host and a given virtualized device, comprising:
an intelligent host bus adapter enabled for network connectivity and analysis;
a software, firmware, or logic utility configured to execute a network probing algorithm; and
a software configuration function configured to assign the optimal virtualization protocol for subsequent data transactions between the host and the virtualized device.
